(19) United States
(12) Patent Application Publication
(10) Pub. No.: US 2003/0232951 A1
(43) Pub. Date: Dec. 18, 2003

(54) Preparation of low loss optical material from difunctional silyl enol ethers and difunctional silanols

(76) Inventor: Reiner Friedrich, Hackett (AU)

Correspondence Address: Gladys H. Monroy, Morrison & Foerster LLP, 755 Page Mill Road, Palo Alto, CA, 94304, US

(21) Appl. No.: 10/167,068

(22) Filed: Jun. 10, 2002

(51) Int. Cl. C08G 77/20; C07F 7/18

(52) U.S. Cl. 528/32; 556/457; 549/215

(57) ABSTRACT

Certain compounds within the general formula (I)

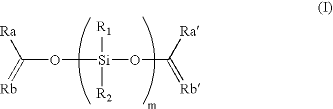

wherein:

Ra and Ra′ are independently alkyl, aryl or aralkyl; Rb and Rb′ are independently CH₂, CH-alkyl, CH-aryl or CH-aralkyl; R₁ and R₂, are independently selected from substituted or unsubstituted alkyl, aryl, aralkyl, heteroaryl, heteroaralkyl; and m is at least 1, and preferably fluorinated or cross-linkable under controlled conditions.

Compounds of formula (I) are reactable with silanediols to produce linear polycondensate organosiloxanes of defined structure without uncontrolled crosslinking. The polycondensates may be cured and are suitable as optical materials.

### FIELD OF THE INVENTION

The invention relates to low loss optical materials, and the preparation thereof, from difunctional silyl enol ethers and difunctional silanols.

### BACKGROUND OF THE INVENTION

Organically modified siloxanes (alternating Si—O backboned polymers) have a broad range of applications. In particular, they have good light transmission properties which make them ideal targets for use in optical materials such as optical fibres and devices. They also generally possess good adhesion as well as mechanical and chemical stability over an extended temperature range.

Siloxane polymers can be divided into two broad classes—

(i) polysiloxanes prepared by the sol-gel route and

(ii) standard siloxane polymers of the polydiorganosiloxane type.

Polysiloxanes prepared by the sol-gel route are sometimes referred to as ORMOSILs (ORganically MOdified SILicates), ORMOCERs (ORganically MOdified CERamics) or inorganic-organic hybrid polymers. These are formed from trialkoxysilanes which are normally hydrolysed in the presence of base or acid to yield the corresponding silanol which then undergoes condensation to give a highly cross-linked polysiloxane.

Problematically, these polymers are difficult to process due to their high viscosity. While the condensation processes can be slowed down somewhat to assist in processing, there is always a tendency for such materials to condense so problems due to high viscosity are inevitable.

A further consequence of this unavoidable condensation is the formation of microgels. These microgels make filtration difficult, particularly the passage through 0.2 μm filters, a step which is essential in preparing optical materials to avoid scattering losses.

WO 01/04186 discloses a method for the condensation of diaryl silanediols with trialkoxy silanes. This produces a polycondensate with the concomitant elimination of alcohol, according to the following scheme:

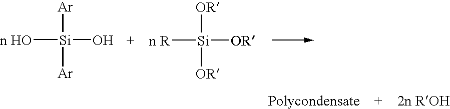

Where the polycondensate can be expressed, in an idealised form, as

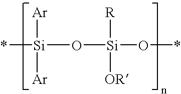

It can be seen that the trialkoxysilanes used in WO 01/04186 are theoretically capable of producing material with uncontrolled cross-linking through the unreacted OR′ group of the polycondensate. Steric hindrance counters this cross-linking to some extent, but nevertheless uncontrolled cross-linking still has a significant effect upon polymer rheology, and processing of these high viscosity polymers is difficult. While ultimately it may be desired to cross-link the polymers, uncontrolled or premature cross-linking is not desirable from a processing point of view. Further, the presence of potentially reactive groups such as OR′ in a cured polycondensate can lead to slow reactions over time which can alter the properties of the polycondensate, including the dimensional stability, and cracking can result.

A common method of preparing siloxanes involves the hydrolysis of silicon alkoxides in organic solution with stoichiometric amounts of water in the presence of catalytic quantities of acid. Such reaction conditions often mean that it is difficult to remove excess OH content (either from water or Si-OH or both) from the reaction mixture.

It is an object of the present invention to overcome or ameliorate at least one of the disadvantages of the prior art, or to provide a useful alternative.

### SUMMARY OF THE INVENTION

According to a first aspect, the invention provides a compound of formula (I)

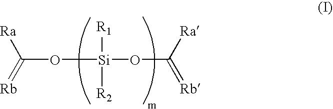

wherein:

Ra and Ra′ are independently alkyl, aryl or aralkyl;

Rb and Rb′ are independently CH₂, CH-alkyl, CH-aryl or CH-aralkyl;

R₁ and R₂, are independently selected from substituted or unsubstituted alkyl, aryl, aralkyl, heteroaryl, heteroaralkyl; and

m is at least 1;

with the proviso that when Ra═Ra′═CH₃ and Rb═Rb′═CH₂ and R₁ is CH₃ then R₂ is not CH₃.

Preferably, Ra═Ra′═CH₃ and Rb═Rb′═CH₂.

Preferably, at least one of R₁ and R₂ is methyl or phenyl.

It is also highly preferred if one or more of R₁ and R₂ are substituted with one or more fluorine atoms, for example, if at least one of R₁ and R₂ is CF₃CH₂CH₂— or CF₃(CF₂)_{z}(CH₂)₂— where z is from 0 to 7.

In other preferred embodiments, at least one of R₁ and R₂ bears a reactive group. Suitable reactive groups include cross-linkable groups, for example alkene, epoxy, acrylate, and methacrylate groups.

In particularly preferred embodiments, R₁ is methyl or phenyl and R₂ is:

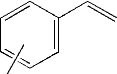

In other particularly preferred embodiments, one of R₁ and R₂ is selected from the group consisting of:

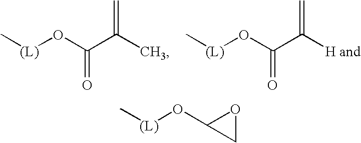

wherein L is —(CH₂)_{q}—, —(OCH₂)q— or —(OCH₂CH₂)_{q}—; and

q is at least 1. It is particularly preferred if q is 3, and most particularly preferred if -(L)- is —(CH₂)₃—.

According to a second aspect, the invention provides a method of synthesising a compound of formula (I)

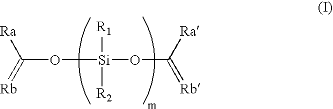

including the step of reacting a dihalide of formula (IV)

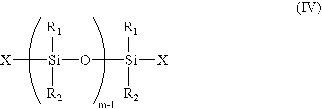

with a ketone of formula (V)

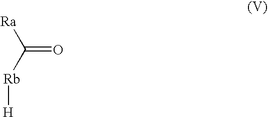

wherein

Ra and Ra′ are independently alkyl, aryl or aralkyl;

Rb and Rb′ are independently CH₂, CH-alkyl, CH-aryl or CH-aralkyl;

R₁ and R₂ are independently alkyl, aryl, aralkyl, heteroaryl, or heteroaralkyl groups, optionally substituted with one or more substituents selected from fluorine and a reactive group; and

m is at least 1.

Preferably X is Cl and the reaction takes place in the presence of NaI. It is preferred that the ketone of formula (V) is acetone.

According to a third aspect the invention provides a polysiloxane of formula (III)

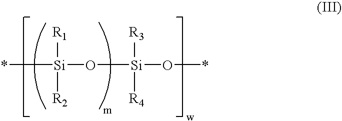

wherein:

R₁, R₂, R₃, R₄ are independently alkyl, aryl, aralkyl, heteroaryl, or heteroaralkyl groups, optionally substituted with one or more substituents selected from fluorine and a reactive group;

m is at least 1; and

w is at least 1.

Preferably, at least one of R₁ and R₂ is methyl or phenyl.

It is also preferred if at least one of R₁, R₂, R₃, or R₄ are substituted with one or more fluorine atoms, for example if at least one of R₁, R₂, R₃, or R₄ is CF₃(CF₂)_{z}(CH₂)₂— with z=0 to 7, and in particular CF₃CH₂CH₂—, CF₃(CF₂)₇(CH₂)₂—, CF₃(CF₂)₅(CH₂)₂— or any other commercially available silane.

In other preferred embodiments at least one of R₁, R₂, R₃, or R₄ bears a reactive group, such as a cross-linkable group. Preferred examples of cross-linkable groups are alkene, epoxy, acrylate, and methacrylate.

Preferably, at least one of R₁, R₂, R₃, or R₄ is independently selected from methyl, phenyl and

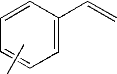

In alternative preferred embodiments, at least one of R₁, R₂, R₃, or R₄ is selected from the group consisting of:

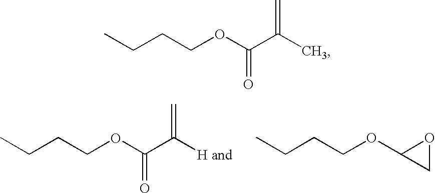

Preferably, the polysiloxane of this third aspect is prepared from a monomer of formula (I). More preferably, the polysiloxanes of the present invention are prepared by the method which includes the preparation of a monomer as defined in the second aspect.

According to a fourth aspect the invention provides a mixed polycondensate of formula (VI)

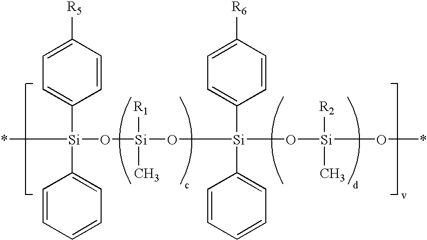

(VI)

wherein R₁ and R₂ are independently selected from CF₃(CH₂)₂—, CF₃(CF₂)₇(CH₂)₂—, CH₃—, H₂C═C(CH₃)COOH(CH₂)₃— or CH₃(CH₂)₇—;

R₅ and R₆ are independently selected from H₂C═CH— and H;

c and d are independently from 1 to 4 inclusive; and

v is at least 1.

According to a fifth aspect the invention provides a method of synthesising a linear organosiloxane of formula (III) comprising condensing a silicon bis(enol ether) of formula (I) with a silane diol of formula (II) according to the following scheme:

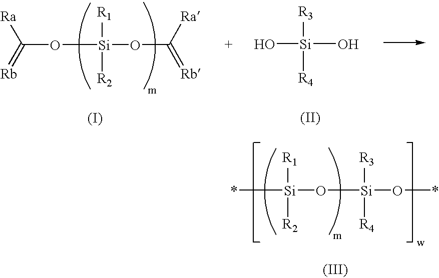

wherein

Ra and Ra′ are independently alkyl, aryl or aralkyl;

Rb and Rb′ are independently CH₂, CH-alkyl, CH-aryl or CH-aralkyl;

R₁, R₂, R₃, R₄ are independently alkyl, aryl, aralkyl, heteroaryl or heteroaralkyl groups, optionally substituted with one or more substituents selected from fluorine and substituents containing a functionalisable sub unit;

m is at least 1; and

w is at least 1.

Preferably, the silane diol of formula (II) is one or more of the compounds selected from:

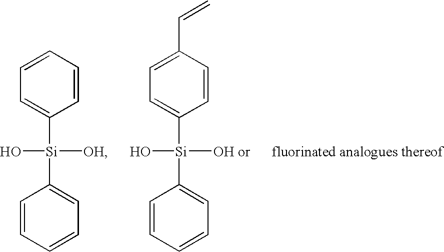

Most preferably R₁ and R₂ are selected in combination to avoid self condensation of the silicon bis(enol ether) (I).

In various preferred embodiments, R₁ and R₂ are independently phenyl or methyl, or alternatively heterocyclic rings selected from the group consisting of:

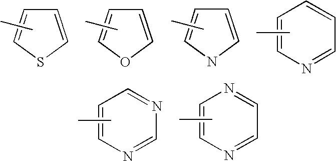

Preferably, R₁ and R₂ are at least partially fluorinated.

According to a sixth aspect the invention provides a method of synthesising a polysiloxane from an oligomeric molecule, according to the following scheme:

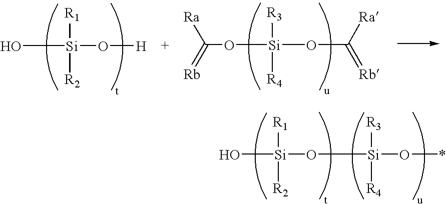

wherein

Ra and Ra′ are independently alkyl, aryl or aralkyl;

Rb and Rb′ are independently CH₂, CH-alkyl, CH-aryl or CH-aralkyl;

R₁, R₂, R₃, R₄ are independently alkyl, aryl, aralkyl, heteroaryl or heteroaralkyl groups, optionally substituted with one or more substituents selected from fluorine and substituents containing a functionalisable sub unit;

t is at least 1; and

u is at least 1.

According to a seventh aspect the invention provides a cyclic compound of formula (VII)

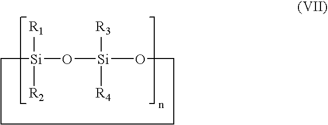

wherein R₁, R₂, R₃, R₄ are independently alkyl, aryl, aralkyl, heteroaryl or heteroaralkyl groups, optionally substituted with one or more substituents selected from fluorine and substituents containing a functionalisable sub unit; and

n is at least 1.

According to an eighth aspect the invention provides a method of removing terminal OH groups from a polysiloxane according to the following scheme:

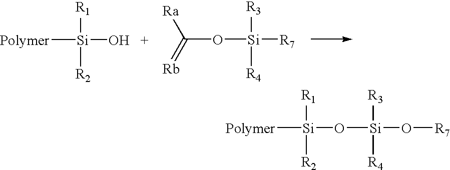

wherein:

Ra is alkyl, aryl or aralkyl;

Rb is CH₂, CH-alkyl, CH-aryl or CH-aralkyl;

R₁, R₂, R₃, R₄ and R₇ are independently alkyl, aryl, aralkyl, heteroaryl or heteroaralkyl groups, optionally substituted with one or more substituents selected from fluorine and substituents containing a functionalisable sub unit.

According to a ninth aspect the invention provides a cured polycondensate prepared by curing a polycondensate derived from at least one compound of formula (I) or by curing a polycondensate of the third, fourth or seventh aspects.

According to a tenth aspect the invention provides a method of preparing a cured polycondensate including the step of treating a polycondensate of the present invention with a curing agent.

Preferably, the curing agent is light and more preferably a photoinitiator is added.

Even more preferably, the light is UV light and the photoinitiator is selected from the group consisting of: 1-hydroxycyclohexylphenyl ketone, benzophenone, 2-chlorothioxanthone, 2-methylthioxanthone, 2-iso-propylthioxanthone, benzoin, 4,4′-dimethoxybenzoin and mixtures thereof.

Alternatively, the light is visible light and the photoinitiator is camphorquinone. In a further alternative preferred embodiment, an initiator is added. Preferably the initiator is dibenzoyl peroxide, t-butyl perbenzoate or azobisisobutyronitrile.

### DETAILED DESCRIPTION OF THE INVENTION

The present invention provides a bis(enol ether) of formula (I)

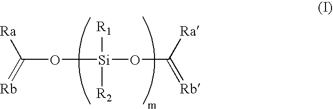

Ra and Ra′ may be independently alkyl, aryl or aralkyl and Rb and Rb′ may independently be CH₂, CH-alkyl, CH-aryl or CH-aralkyl. Ra and Ra′ do not have to be identical, nor do Rb and Rb′ although this will often be the case. Similarly, Rb will usually be a dehydro Ra, and Rb′ will usually be a dehydro Ra′, although this does not need to be the case in the present invention.

In the simplest form of the invention, m is 1, although the compound may be based on longer chain polysiloxanes.

Usually, Ra═Ra′═CH₃ and Rb═Rb′═CH₂.

R₁ and R₂ may be a variety of functional groups, such as substituted or unsubstituted alkyl, aryl, aralkyl, heteroaryl or heteroaralkyl. It is contemplated in a non limiting way that most R₁ and R₂ groups will have less than 20 carbon atoms, or less than 20 carbon and hetero atoms.

Those skilled in the art will understand the term alkyl to include any group derived from an alkane, which may be unbranched (linear) such as, but not limited to, methyl, ethyl, n-propyl, n-butyl, hexyl, octyl etc; branched such as, but not limited to, isopropyl, sec-butyl, tert-butyl and the like; cycloalkyl, such as, but not limited to, cyclohexyl, or cyclopentyl.

R₁ and R₂ may be for example methyl, ethyl, propyl, butyl, pentyl, hexyl, heptyl, octyl, nonyl or decyl, or for instance phenyl, naphthyl, phenanthryl, anthracyl or include heteroaromatic rings, such as pyrrole, thiophene, furan, pyridine, pyrazine and the like. They may also be substituted, for example with vinyl, acrylate or methacrylate groups. The scope of these terms encompasses also those substituents which have ether, thioether, ester, amide and the like links.

Those skilled in the art will appreciate that the term aralkyl encompasses hybrid aryl/alkyl systems.

It is desirable that one or more of R₁ and R₂ are substituted with one or more fluorine atoms, in order to reduce the adverse effects of C—H bonds in materials where high light transmission properties are acceptable. The fluorine atoms may replace some or all of the hydrogen atoms. Examples of suitable substituents include, but are not limited to CF₃(CF₂)_{z}(CH₂)₂— with z from 0 to 7, and in particular 3,3,3-trifluoropropyl (CF₃CH₂CH₂—), 1H,1H,2H,2H-perfluorodecyl (CF₃(CF₂)₇(CH₂)₂—) or 1H,1H,2H,2H-perfluorooctyl (CF₃(CF₂)₅(CH₂)₂—). Any partially or fully perfluorinated analogue of the substituents mentioned herein will be useful as a substituent provided it has adequate chemical stability.

It is also desirable that at least one of R₁ and R₂ bears a reactive group. Reactive groups can be used to further functionalise molecules, and can include for instance OH, CN, NH₂ (and N-aryl and N-alkyl amines and N,N-diaryl and N,N-dialkylamines), N₃, SH, COOH, carbonyl compounds, amides, alkenes, alkynes and the like.

Those skilled in the art will understand that the permutations of reactive groups available are extensive.

One particularly desirable functionalisation includes providing the monomers of the present invention with groups which can be self reactive under controlled conditions. In this way, the groups can be introduced into the monomers, reacted to give polycondensates, and then cured to effect cross-linking as desired. Thus, it is highly desirable to incorporate into the bis enol ethers a reactive group which is cross-linkable.

Examples of particularly preferred cross-linkable groups are alkene, epoxy, acrylate, and methacrylate.

An example of what is meant by an alkene cross-linkable group is styrene. Styrene can be present both as R₁ and R₂, or it can be present as just one of R₁ and R₂, for example, R₁ is methyl or phenyl and R₂ is:

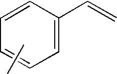

Other examples of R₁ and R₂ include:

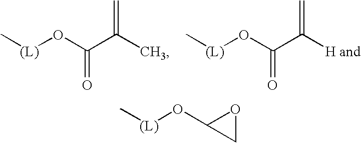

L can be a variety of linkers such as —(CH₂)_{q}—, —(OCH₂)_{q}— or —(OCH₂CH₂)_{q}—.

Concrete examples include:

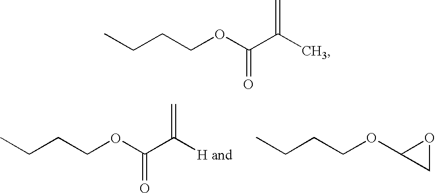

The value of q can be any value and may be selected for example, in conjunction with the other functionalities in the molecule. Longer linkers may be desirable, for example, when there are other bulky substituents in the molecule. In most circumstances, it would be expected that q would be selected to provide a chain linker less than about 20 atoms long. A particularly preferred chain length arises where -(L)- is —(CH₂)₃—.

The compounds of formula (I)

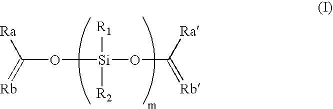

may be synthesised by reacting a dihalide of formula (IV)

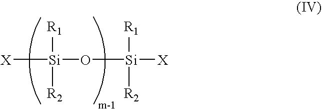

with a ketone of formula (V)

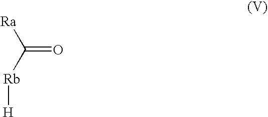

The reaction is typically carried out in an inert polar solvent. X is usually Cl or Br and an iodide salt (usually NaI or KI) is added.

It is particularly preferred to use acetone as the ketone, because of its availability, cost and relative safety. Acetone gives rise to Ra and Ra′ being CH₃ and Rb and Rb′ being CH₂. This also has the advantage that these are relatively low steric bulk groups, although it will be appreciated that different ketones, eg methyl ethyl ketone (MEK) or acetophenone could be used. The only requirement is that at least one alpha hydrogen is present to allow enolisation to occur.

Those skilled in the art will appreciate that a mixture of two or more different symmetrical and/or asymmetrical ketones could be employed. This may present the opportunity to achieve differential reactivity of the two ends of the polymer chain.

The value of m is determined by the size of the starting siloxane. It may be one in the case where both halides are bonded to the silicon. It could be longer, although ensuring structural precision becomes more difficult in very long chains. Examples of suitable chains, which can increase the molecular mass, would have between 4 and 10 repeating Si—O units in the chain.

Those skilled in the art will appreciate that the schemes provided herein do not provide a rigid stoichiometric analysis of each reaction, but rather are used to illustrate the inventive concept. Those skilled in the art will appreciate the stoichiometric ratios, by-products and the like involved in carrying out the present reactions.

The invention allows access to polysiloxanes of formula (III)

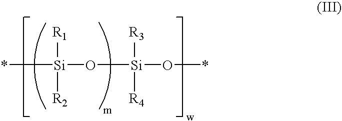

to be produced, with R₁, R₂, R₃, R₄ and m as discussed above. The value of w may range from 1 in the case of a monomer to tens or even up to hundreds of thousands in polymers or higher—the size depends upon the reactivity and length of time of reaction, concentration etc. However, the exact size is unimportant as the physical properties of the polymer are defined once a certain size is reached (ie once the material becomes greater than an oligomer) and increasing w further will not change the polymeric properties.

The nature of R₁, R₂, R₃, and R₄ may all be varied by using mixtures of two, three, four or more different starting compounds of formula I and/or mixtures of two, three, four or more different starting dihalides.

The formula above is idealised, with * being used to indicate that the chain termini are not particularly important when w is large. The * may represent, for example, OH in the original silanediol used or the reactive enol ether group, or a terminated chain, such as with reaction with a chain terminating species like atmospheric moisture or a specific chain terminator as disclosed in more detail below.

The present invention also encompasses the use of mixtures of enol ethers and mixtures of silane diols. In this way, the use of reactive or cross-linking groups can modulated by the insertion of inert or non-cross-linking groups. The former are likely to be more expensive than the latter, and the incorporation of reactive groups which may be un-cross-linkable (due to the polycondensate matrix becoming more rigid) would increase material cost unnecessarily, and may even lead to adverse reactions, eg cross-linkable groups which cannot “find” another cross-linkable group in a polycondensate may ultimately react over time with for example, atmospheric moisture or oxygen, leading to a lack of stability in the product.

The present invention thus contemplates mixed polycondensates of formula (VI)

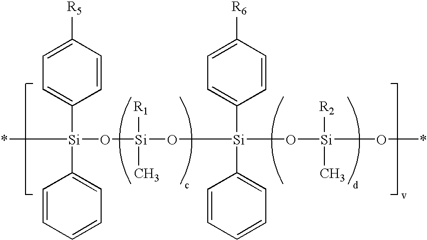

(VI)

wherein R₁ and R₂ are independently as disclosed above, and in particular, are selected from CF₃(CH₂)₂—, CF₃(CF₂)₇(CH₂)₂— (or like groups such as CF₃(CF₂)₇(CH₂)₂—), CH₃—, H₂C═C(CH₃)COOH(CH₂)₃— or CH₃(CH₂)₇—; R₅ and R₆ are independently selected, in particular, from H₂C═CH— and H; c and d are independently from 1 to 4 inclusive; and v is at least 1, but more particularly represents a polymer of 100, 1000, 10000 or 100000 for example.

The invention also relates to a method of synthesising a linear organosiloxane of formula (III) comprising condensing a silicon bis(enol ether) of formula (I) with a silane diol of formula (II) according to the following scheme:

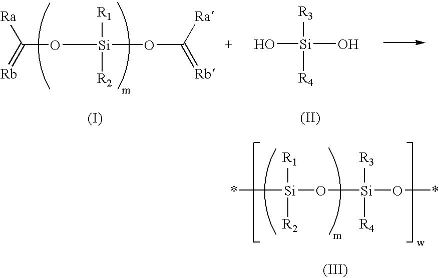

with the various groups as hereinbefore described.

Preferably, the reaction may be carried out in the presence of a catalyst. Tin catalysts are particularly preferred. Most preferred is tin(II)ethylhexanoate. Tin(II)triflate may also be used, as may any other suitable catalyst. Examples of the classes of compounds and specific examples of compounds which may be used as catalysts include: metal salts of organic carboxylic acids, such as lead-di-2-ethyloctoate, dibutyl-tin-diacetate, dibutyl-tin-dilaurate, butyl-tin-tri-2-ethylhexoate, stannous dicapriate, stannous dinaphtate, stannous dioleate, stannous dibutyrate, titanium tetranaphtate, zinc dinaphtate, zinc distearate, zinc-di-2-ethylhexoate, iron-2-ethylhexoate, cobalt-2-ethylhexoate, and manganese-2-ethylhexoate; organic titanium compounds, such as tetrabutyltitanate, tetra-2-ethylhexyltitanate, tetraphenyltitanate, tetraoctadecyltitanate, tetraoctyleneglycoltitanate, tetraorganosiloxytitanate, and dialkoxytitanium bisacetylacetonate; tetraalkenyloxytitanium compounds, such as tetraisopropenoxytitanium, tetra-1,2-dimethyl-1-propenoxytitanium, and tetra-1-methyl-1-propenoxytitanium; aluminium alkoxides, such as aluminiumtriisopropoxide; aminoalkyl-substituted alkoxysilanes, such as γ-aminopropyl triethoxysilanes and N-trimethoxysilylpropyl ethylenediamine; amines, such as n-hexylamine, dodecylamine phosphate, and benzyltriethylamine acetate; ammonium salts; quaternary ammonium salts; and alkaline metal carboxylates, such as potassium acetate, sodium acetate, and dilithium oxalate.

Particular examples of the silane diol of formula (II) are one or more of the compounds selected from:

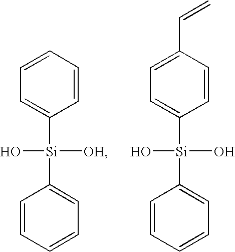

or fluorinated analogues thereof, or mixtures thereof.

The groups R₁ and R₂ should be selected so that, in combination, and in combination with the particular reaction conditions, they avoid self-condensation of the silicon bis(enol ether) (I). For example, a person skilled in the art would not choose as a combination an R₁ which was an alkyl chloride and R₂ which was an amine. Similarly, some reactive groups should be protected from light, acid or base during preparation. The nature of the sensitivities of various functional groups is well known to those skilled in the art and is well documented in patent and non-patent literature.

Some of R₁ and R₂ may be independently chosen to be phenyl or methyl to decrease the number of reactive groups in the resultant polymer, to modulate cross-linking and obviate the presence of unreacted groups. These non-reactive groups are good candidates for the site of fluorine incorporation into the molecule.

R₃ and R₄ are for example independently heterocyclic rings (which may also be fluorinated) selected from the group consisting of:

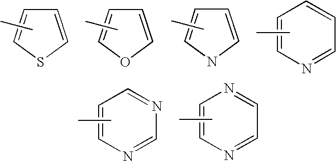

The invention also provides a method of synthesising a polysiloxane from an oligomeric molecule, according to the following scheme:

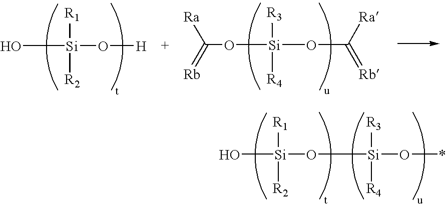

wherein the groups are as described above and t is at least 1; and u is at least 1, and * has the meaning as explained previously. Preferably, t and u are both selected so that the starting compounds are oligomeric, for example t and u may be less than 20, less than 10 or less than 5, for example 2, 3, or 4 repeating units. This illustrates that the silanes, as well as the siloxanes, can be any extended compounds, provided that the correct end functionalities are present.

The reaction also encompasses cyclic compounds of formula (VII)

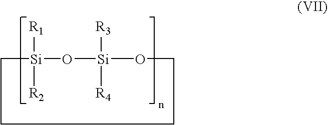

These can have any number of groups provided steric strain is overcome. Those skilled in the art will appreciate that these compounds may be favoured for particular intermediate ring sizes and may more particularly be produced by selecting conditions which promote intra-, rather than inter-molecular interactions, eg conditions of high dilution. These cyclic compounds may also include cross-linkers.

As mentioned above, the exact chemical identity of the termini of the chain are of minor concern in high molecular weight polymers, where the properties are determined by the repeating or statistically controlled nature of the chain. Some chain propagation is terminated by atmospheric moisture, while some is terminated by an inability to react due to the groups becoming isolated in the polycondensate matrix. In this regard, the present invention also provides a method of removing terminal OH groups from a polysiloxane according to the following scheme:

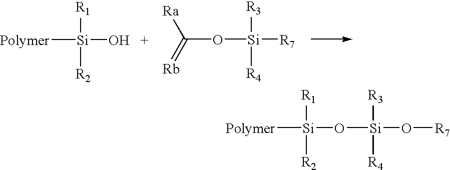

where R₇ may be any non-reactive component specified before in relation to any other R group, or it may be a fluorinated group. R₇ may be a group which allows insertion of a new reactive moiety into the polycondensate.

The polycondensates of the present invention, when cross-linkable groups are included, may also be cured. This may take place by the exposure of the polycondensate to a curing agent. The curing agent may be light, especially UV light which is particularly preferred in the case of styryl cross-linking agents. A suitable photoinitiator may be added, for example 1-hydroxycyclohexylphenyl ketone, benzophenone, 2-chlorothioxanthone, 2-methylthioxanthone, 2-iso-propylthioxanthone, benzoin, 4,4′-dimethoxybenzoin or mixtures thereof. If the light is visible light, camphorquinone may be added.

Other initiators, eg radical initiators, may be added. These other initiators may include dibenzoyl peroxide, t-butyl perbenzoate or azobisisobutyronitrile. Those skilled in the art will understand that the nature of the initiator chosen will depend upon the nature of the reactive groups involved.

An advantage of the polymers of the present invention is that they possess low concentrations of OH groups, these being present at an average amount of one per linear polymer molecule. For extended, high weight polymers, this is a very low figure. In fact, in any reaction mixture of the present invention, there will be slightly less than one OH group per molecule because of the presence of some cyclised molecules such as those illustrated.

In contrast to methods of synthesis such as those disclosed in WO 01/04186, the reaction of forming the polysiloxanes of the present invention takes place only on the termini of the chain. In the syntheses of WO 01/04186, where a reaction occurs between partially formed oligomeric species, the reaction could take place anywhere on the chains. In the present invention, a reaction between oligomeric species takes place only at the end of the chain, so any inter-chain reactions simply produce a longer, linear chain. Apart from cyclisation, which ends the process, there are in essence no competing reactions in the method of the present invention, leading to a product of high purity. The only variable in the product is thus chain length.

The polymers of the present invention also possess low viscosities, which aid in processing (eg filtration) and in spin coating.

The polymers of the present invention also possess the advantage that, as a by-product, they produce only ketones. The particular ketone produced will depend upon the structure of the starting materials but in highly preferred embodiments, where Ra and Rb are methyl, the ketone produced is acetone. Those skilled in the art will appreciate that acetone can be readily removed from reactions, for example by mild distillation (eg reduced pressure at room temperature).

Cross-linking of the polymeric products of the present invention can be carried out in two ways—in a highly controlled way by using moieties which will be inert under the siloxane condensation reaction conditions, or by adding trifunctional agents for example, tri-(4-styryl)methane in predetermined amounts to the reaction mixture.

The more controlled method of cross-linking the polymeric product of the present invention involves preparing a polymer incorporating a cross-linkable group. In the following non-limiting example, a styryl bearing monomer is used to prepare a siloxane polymer. The resultant linear polymers, each bearing a number of styryl groups, depending on the stoichiometric amount used, can then be reacted.

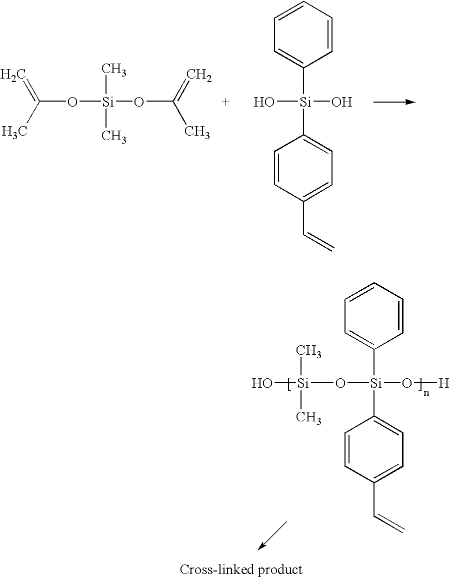

The viscosity of the product and degree of cross-linking can also be increased by the addition of trifunctional agents in stoichiometrically predetermined amounts. Such trifunctional agents include trifunctional silicon ethers and/or silane triols. These trifunctional cross-linking agents can be used alone to modify siloxane properties, or can be used in combination with the selectable cross-linkable agents, such as styrenes, or used on their own.

If it is not desired to further functionalise or cross-link the polymer subsequent to its production, then diaryl compounds, where R₁═R₂═ phenyl are generally preferred as the substituents on the silane diol starting material (because they are readily available and stable in hydrolysed form) and R₃ and R₄ are also selected from non functionalisable/non cross-linkable substituents.

The general experimental procedure involves mixing together a 1:1 molar ratio of the silane diol and the silicon enol ether.

If oligomers are used, the molar ratio of the components will need to be adjusted accordingly, to ensure there is a 1:1 stoichiometric ratio of condensable OH groups and silyl enol ether groups.

When the reaction is complete, the catalyst is removed by filtration. Again, more acetone can be added at this time if the solution is too viscous.

The product is obtained in virtually a quantitative yield, the only product loss being due to sample loss on handling.

Those skilled in the art will appreciate that the synthetic procedures referred to herein will produce statistical polymers. While these are described herein in somewhat idealised terms, those skilled in the art will appreciate that the statistical nature of the synthesis will often mean that, in reality, in some cases the polymers will not have extended regions of alternating units. However, in all cases, the molecular formula is substantially identical to the idealised formula.

### EXAMPLES

Sample Preparation and Measurement.

All resins described in examples 1-8 were filtered through a 0.2 μm filter after preparation.

The optical loss was measured with a SHIMADZU UV-VIS-NIR spectrophotometer (UV-3101 PC) using a 0.5 cm quartz cuvette. Since the resins are colourless, the absorption was calibrated using the zero absorption area ≦700 nm as baseline. The absorption spectrum from the resin was measured from 3200 nm-200 nm. The lowest absorption value (usually the absorption between 700 and 550 nm is a straight line if there is no scattering as a result of particles and if the resin is colourless) is set as 0 absorption. The loss in dB/cm is calculated from the optical density of the resin at 1310 and 1550 nm, multiplied by 10 and divided by the thickness of the cuvette in cm (whereas the optical density equals the log to the base 10 of the reciprocal of the transmittance). The loss was estimated from the un-cured resin only.

The refractive index was estimated by a standard refractometer using daylight as the light source.

Synthesis

Synthesis of n-octylmethyldiisopropenoxysilane

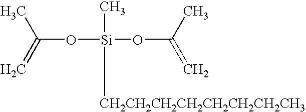

In a 2 L three neck round bottom flask equipped with a 500 ml magnetic stirrer bar, dropping funnel, nitrogen inlet and condenser, 149.89 g (1.0 mol) of dry NaI was dissolved in 1 L acetonitrile and 113.62 g (0.5 mol) of n-octylmethyldichlorosilane was added to the solution. After stirring the mixture at room temperature for 10 min, 101.19 g (1.0 mol) triethylamine was added, followed by 116.16 g (2.0 mol) acetone (slightly exothermic reaction). After 2 h at room temperature the reaction mixture was poured onto 1 L of ice water and extracted twice with 250 ml petrol ether. The combined organic phase was dried over MgSO₄, the solvent driven off in a rotary evaporator and the crude product distilled under reduced pressure.

Yield: 66%=89.52 g (0.33 mol) n-octylmethyldiisopropenoxysilane (b.p. 74-78° C./2.0*10⁻² mbar).

Synthesis of Bis(enol Ethers)

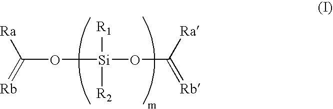

In a similar manner to the procedure for n-octylmethydiisopropenoxysilane, the following compounds were synthesised:

| Compound | yield | b.p. (mbar) |
|---|---|---|
| Dimethyldiisopropenoxysilane | 60% | 44-45° C. (40) |
| Ra = Ra′ = CH₃, Rb = Rb′ = CH₂ | | |
| R₁ = R₂ = CH₃, m = 1 | | |
| 3,3,3-Trifluoropropylmethyldiisopropenoxysilane | 73% | 36-37° C. (3.0) |
| Ra = Ra′ = CH₃, Rb = Rb′ = CH₂ | | |
| R₁ = CH₃, R₂ = CF₃CH₂CH₂, m = 1 | | |
| Phenylmethyldiisopropenoxysilane | 80% | 67-68° C. |
| | | (3.0*10⁻¹) |
| Ra = Ra′ = CH₃, Rb = Rb′= CH₂ | | |
| R₁ = CH₃, R₂ = Phenyl, m = 1 | | |
| 1H, 1H, 2H, 2H- | 70% | 75-78° C. |
| | | (1.0*10⁻¹) |
| Perfluorodecylmethyldiisopropenoxysilane | | |
| Ra = Ra′ = CH₃, Rb = Rb′ = CH₂ | | |
| R₁ = CH₃, R₂ = CF₃(CF₂)₇CH₂CH₂, m = 1 | | |
| 1,7-Diisopropenoxyoctamethyltetrasiloxane | 79% | 68-70° C. |
| | | (2.9*10⁻¹) |
| Ra = Ra′ = CH₃, Rb = Rb′ = CH₂ | | |
| R₁ = R₂ = CH₃, m = 4 | | |

Synthesis of 4-vinyldiphenylsilanediol

A 500 ml three neck round bottom flask equipped with a nitrogen inlet, stirrer and condenser was charged with 19.00 g (0.78 mol) magnesium turnings. Under a nitrogen atmosphere, 125 ml of anhydrous THF and 125 ml of anhydrous diethylether were added followed by 98.75 g (0.71 mol) of 4-chlorostyrene. The mixture was kept at 50° C. for 16 h to form a Grignard solution.

A two litre three neck round bottom flask equipped with a nitrogen inlet, dropping funnel and condenser was charged with 423.86 g (2.14 mol) phenyltrimethoxysilane. The system was purged with nitrogen and the Grignard solution was transferred into the dropping funnel. The flask was heated to 50C, then the Grignard solution was added over a period of 40 min and kept at this temperature for an additional 2 h.

The reaction was allowed to cool to room temperature, 1 litre of petroleum ether was added, the precipitated salt was separated by filtration and the solvent was distilled off. The product was distilled under reduced pressure using 2.00g of 2-methyl-1,4-naphthoquinone and 2.00g N,N-diphenylhydroxylamine as polymerisation inhibitors.

Yield: 64%=122.73 g (0.45 mol) 4-vinyldiphenyldimethoxysilane (bp.112-118C @ 2.5*10⁻³ mbar).

160.00 g (0.59 mol) 4-vinyldiphenyldimethoxysilane was dissolved in 400 ml isopropanol and 125 ml 1 M acetic acid was added. The solution was stirred at room temperature for 48 h and 300 ml of the solvents were distilled off. The solution was neutralised with saturated aqueous NaHCO₃ solution and extracted twice with 200 ml ethyl acetate. The organic layer was dried over MgSO₄ and the solvents distilled off under reduced pressure. The crude product was ground and extracted with petroleum ether in a Soxhlet apparatus.

Yield: 63%=89.87 g (0.371 mol) 4-vinyldiphenylsilanediol.

Synthesis of the Polycondensate Resins with the General Structure

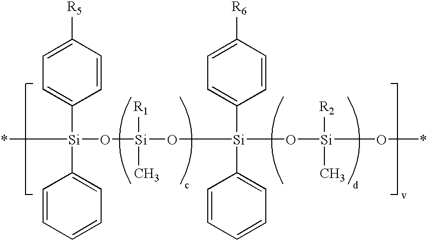

### Example 1

### R₁,R₂═CF₃(CH₂)₂—; R₅═H₂C═CH—; R₆═H—; c, d=1

8.65 g (40 mmol) diphenylsilane diol (DPS), 9.69 g (40 mmol) 4-vinyldiphenylsilane diol (VDPS), 20.34 g (80 mmol) 3,3,3-trifluoropropylmethyldiisopropenoxysilane and 20 ml anhydrous acetone were placed in a 100 ml round bottom flask equipped with a magnetic stirrer bar and a condenser. 0.4 g (1.0 mmol) Tin(II)ethylhexanoate was dissolved in 2 ml anhydrous acetone and added to the stirred reaction mixture. After stirring for 24 h at room temperature, the solvent is driven off under reduced pressure and the crude resin is dissolved in 100 ml petrol ether. To remove the catalyst and any coloured by-products the mixture is filtered through 10 g of silica gel. The solvent is driven off under reduced pressure and the resin is filtered through a 0.2 μm filter.

Selected Physical Properties:

Refractive index: n_{D}²¹ 1.5170

Optical loss: 0.17 dB/cm @1310 nm, 0.39 dB/cm @ 1550 nm

### Example 2

### R₁, R₂═CF₃(CF₂)₇(CH₂)₂—; R₅H₂C═CH—; R═H—; c, d=1

2.16 g (10 mmol) DPS

2.42 g (10 mmol) VDPS

12.08 g (20 mmol) 1H,1H,2H,2H-Perfluorodecylmethyldiisopropenoxysilane

0.04 g (0.1 mmol) Tin(II)ethylhexanoate

Synthetic procedure was the same as for example 1.

Selected Physical Properties:

Refractive index: n_{D}²¹ 1.4321

Optical loss: 0.14 dB/cm 11310 nm, 0.34 dB/cm @ 1550 nM

### Example 3

### R₁, R₂═CH₃—; R₅═H₂C═CH—; R₆═H—; c, d=1

2.16 g (10 mmol) DPS

2.42 g (10 mmol) VDPS

3.44 g (20 mmol) Dimethyldiisopropenoxysilane

0.04 g (0.1 mmol) Tin(II)ethylhexanoate

Synthetic procedure was the same as for example 1.

Selected Physical Properties:

Refractive index: n_{D}²¹ 1.5530

Optical loss: 0.34 dB/cm @1310 nm, 0.78 dB/cm @ 1550 nm

### Example 4

### R₁, R₂═(H₂C═C(CH₃)CO₂(CH₂)₃—; R₅═H₂C═CH—, R₆═H—; c, d=1

2.16 g (10 mmol) DPS

2.42 g (10 mmol) VDPS

12.08 g (20 mmol) 3-Methacryloxypropylmethyldiisopropenoxysilane

0.04 g (0.1 mmol) Tin(II)ethylhexanoate

Synthetic procedure was the same as for example 1.

Selected Physical Properties:

Refractive index: n_{D}²¹ 1.5339

Optical loss: 0.17 dB/cm @1310 nm, 0.57 dB/cm @ 1550 nm

### Example 5

### R₁, R₂═(CH₃(CH₂)₇—; R₅═H₂C═CH—; R₆═H—; c, d=1

2.16 g (10 mmol) DPS

2.42 g (10 mmol) VDPS

5.41 g (20 mmol) n-Octylmethyldiisopropenoxysilane

0.04 g (0.1 mmol) Tin(II)ethylhexanoate

Synthetic procedure was the same as for example 1.

Selected Physical Properties:

Refractive index: n_{D}²¹ 1.5152

Optical loss: 0.46 dB/cm @1310 nm, 0.90 dB/cm @ 1550 nm

### Example 6

### R₁, R₂═CH₃—; R₅═H₂C═CH—; R₆═H—; c, d=1

2.16 g (10 mmol) DPS

2.42 g (10 mmol) VDPS

7.89 g (20 mmol) 1,7-Diisopropenoxyoctamethyltetrasiloxane

0.04 g (0.1 mmol) Tin(II)ethylhexanoate

Synthetic procedure was the same as for example 1.

Selected Physical Properties:

Refractive index: n_{D}²¹ 1.4806

Optical loss: 0.17 dB/cm @1310 nm, 1.12 dB/cm @ 1550 nm

### Example 7

### R₁═CH₃—; R₂═CF₃(CF₂)₇(CH₂)₂—; R₅═H₂C═CH—; R₆═H—; d=1, c=4

2.16 g (10 mmol) DPS

2.42 g (10 mmol) VDPS

3.95 g (10 mmol) 1,7-Diisopropenoxyoctamethyltetrasiloxane

6.04 g (10 mmol) 1H,1H,2H,2H-Perfluorodecylmethyldipropenoxysilane

0.06 g (0.1 mmol) Tin(II)ethylhexanoate

Synthetic procedure was the same as for example 1.

Selected Physical Properties:

Refractive index: n_{D}²¹ 1.4610

Optical loss: 0.17 dB/cm @11310 nm, 0.76 dB/cm @ 1550 nm

### Example 8

### R₁, R₂═CF₃(CF₂)₇(CH₂)₂—; R₅, R₆═H₂C═CH—; c, d=1

2.42 g (10 mmol) VDPS

6.04 g (10 mmol) 1H,1H,2H,2H-Perfluorodecylmethyldiisopropenoxysilane

0.04 g (0.1 mmol) Tin(II)ethylhexanoate

Synthetic procedure was the same as for example 1.

Selected Physical Properties:

Refractive index: n_{D}²¹ 1.4321

Optical loss: 0.16 dB/cm @1310 nm, 0.44 dB/cm @ 1550 nm

Curing

The material produced in example 1 was mixed with 2 wt % Irgacure 1000 as photoinitiator and stirred under the exclusion of light for 24 hours. 2 ml of this mixture was spun onto a 10 cm Si-wafer at 4000 rpm for 60s. The wafer was exposed to UV-light using a Hg arc lamp with 8 mW/cm² intensity for 60 s under a nitrogen atmosphere. The thickness of the film was 12.8 μm.

The invention has been described by reference to certain preferred embodiments; however, it should be understood that it may be embodied in other specific forms or variations thereof without departing from its spirit or essential characteristics. The embodiments described above are therefore considered to be illustrative in all respects and not restrictive, the scope of the invention being indicated by the appended claims rather than by the foregoing description.

1. A compound of formula (I) 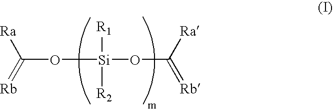
wherein:
Ra and Ra′ are independently alkyl, aryl or aralkyl;
Rb and Rb′ are independently CH₂, CH-alkyl, CH-aryl or CH-aralkyl;
R₁ and R₂, are independently selected from substituted or unsubstituted alkyl, aryl, aralkyl, heteroaryl, heteroaralkyl; and
m is at least 1;
with the proviso that when Ra═Ra′═CH₃ and Rb═Rb′═CH₂ and R₁ is CH₃ then R₂ is not CH₃.

2. A compound according to claim 1 wherein Ra═Ra′═CH₃ and Rb═Rb′═CH₂.

3. A compound according to claim 1 wherein at least one of R₁ and R₂ is methyl.

4. A compound according to claim 1 wherein at least one of R₁ and R₂ is phenyl.

5. A compound according to claim 1 wherein one or more of R₁ and R₂ are substituted with one or more fluorine atoms.

6. A compound according to claim 5 wherein at least one of R₁ and R₂ is CF₃CH₂CH₂—

7. A compound according to claim 5 wherein at least one of R₁ and R₂ is CF₃(CF₂)_{z}(CH₂)₂— where z is from 0 to 7.

8. A compound according to claim 1 wherein at least one of R₁ and R₂ bears a reactive group.

9. A compound according to claim 8 wherein the reactive group is a cross-linkable group.

10. A compound according to claim 9 wherein the cross-linkable group is selected from alkene, epoxy, acrylate, and methacrylate.

11. A compound according to claim 1 wherein R₁ is methyl and R₂ is:

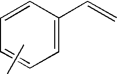

12. A compound according to claim 1 wherein R₁ is phenyl and R₂ is:

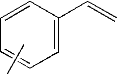

13. A compound according to claim 1 wherein one of R₁ and R₂ is selected from the group consisting of: 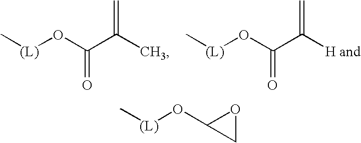
wherein L is —(CH₂)_{q}—, —(OCH₂)_{q}— or —(OCH₂CH₂)_{q}—; and
q is at least 1.

14. A compound according to claim 13 wherein -(L)- is —(CH₂)₃—.

15. A method of synthesising a compound of formula (I) 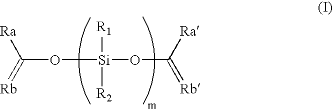
including the step of reacting a dihalide of formula (IV) 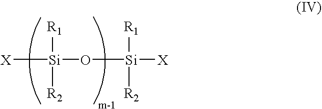
with a ketone of formula (V) 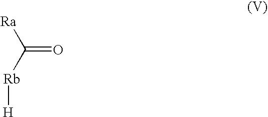
wherein
Ra and Ra′ are independently alkyl, aryl or aralkyl;
Rb and Rb′ are independently CH₂, CH-alkyl, CH-aryl or CH-aralkyl;
R₁ and R₂ are independently alkyl, aryl, aralkyl, heteroaryl, or heteroaralkyl groups, optionally substituted with one or more substituents selected from fluorine and a reactive group; and
m is at least 1, with the proviso that when Ra═Ra′═CH₃ and Rb═Rb′═CH₂ and R₁ is CH₃ then R₂ is not CH₃.

16. A method according to claim 15 wherein X is Cl and the reaction takes place in the presence of NaI.

17. A method according to claim 15 wherein the ketone of formula (V) is acetone.

18. A polysiloxane of formula (III) 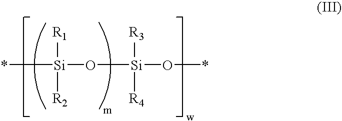
wherein:
R₁, R₂, R₃, R₄ are independently alkyl, aryl, aralkyl, heteroaryl, or heteroaralkyl groups, optionally substituted with one or more substituents selected from fluorine and a reactive group;
m is at least 1; and
w is at least 1.

19. A polysiloxane according to claim 18 wherein at least one of R₁ and R₂ is methyl.

20. A polysiloxane according to claim 18 wherein at least one of R₁ and R₂ is phenyl.

21. A polysiloxane according to claim 18 wherein at least one of R₁, R₂, R₃, or R₄ are substituted with one or more fluorine atoms.

22. A polysiloxane according to claim 18 wherein at least one of R₁, R₂, R₃, or R₄ is CF₃CH₂CH₂—.

23. A polysiloxane according to claim 18 wherein at least one of R₁, R₂, R₃, or R₄ is CF₃(CF₂)_{z}(CH₂)₂— where z is from 0 to 7.

24. A polysiloxane according to claim 18 wherein at least one of R₁, R₂, R₃, or R₄ bears a reactive group.

25. A polysiloxane according to claim 24 wherein the reactive group is a cross-linkable group.

26. A polysiloxane according to claim 25 wherein the cross-linkable group is selected from alkene, epoxy, acrylate, and methacrylate.

27. A polysiloxane according to claim 18 wherein at least one of R₁, R₂, R₃, or R₄ is independently selected from methyl, phenyl and

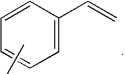

28. A polysiloxane according to claim 18 wherein at least one of R₁, R₂, R₃, or R₄ is selected from the group consisting of:

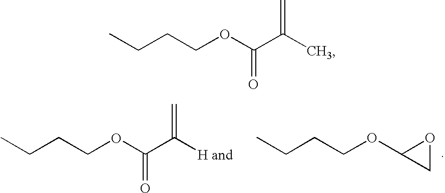

29. A polysiloxane according to claim 18 prepared from a monomer of formula (I) as defined in claim 1.

30. A mixed polycondensate of formula (VI) 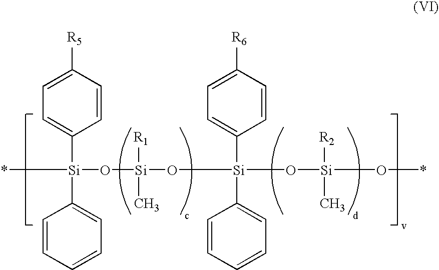
wherein R₁ and R₂ are independently selected from CF₃(CH₂)₂—, CF₃(CF₂)₇(CH₂)₂—, CH₃—, H₂C═C(CH₃)COOH(CH₂)₃— or CH₃(CH₂)₇—;
R₅ and R₆ are independently selected from H₂C═CH— and H;
c and d are independently from 1 to 4 inclusive; and
v is at least 1.

31. A method of synthesising a linear organosiloxane of formula (III) comprising condensing a silicon bis(enol ether) of formula (I) with a silane diol of formula (II) according to the following scheme: 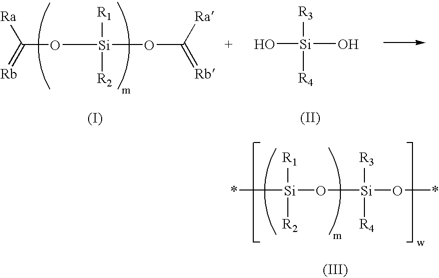
wherein
Ra and Ra′ are independently alkyl, aryl or aralkyl;
Rb and Rb′ are independently CH₂, CH-alkyl, CH-aryl or CH-aralkyl;
R₁, R₂, R₃, R₄ are independently alkyl, aryl, aralkyl, heteroaryl or heteroaralkyl groups, optionally substituted with one or more substituents selected from fluorine and substituents containing a functionalisable sub unit;
m is at least 1; and
w is at least 1.

32. A method according to claim 31 wherein the silane diol of formula (II) is one or more of the compounds selected from:

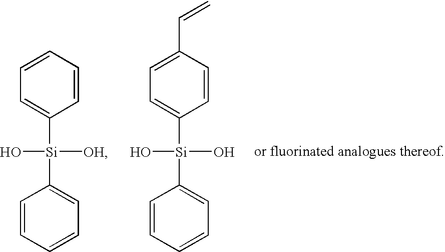

33. A method according to claim 31 wherein R₁ and R₂ are selected in combination to avoid self-condensation of the silicon bis(enol ether) (I).

34. A method according to claim 31 wherein R₁ and R₂ are independently phenyl or methyl.

35. A method according to claim 31 wherein R₃ and R₄ are independently heterocyclic rings selected from the group consisting of:

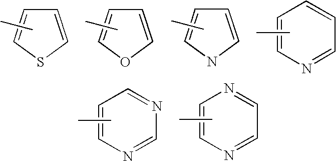

36. A method according to claim 35 wherein the heterocyclic rings are at least partially fluorinated.

37. A method of synthesising a polysiloxane from an oligomeric molecule, according to the following scheme: 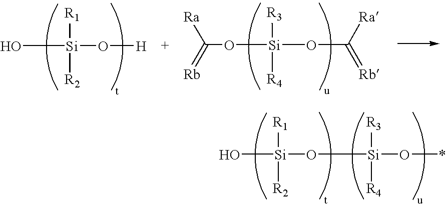
wherein
Ra and Ra′ are independently alkyl, aryl or aralkyl;
Rb and Rb′ are independently CH₂, CH-alkyl, CH-aryl or CH-aralkyl;
R₁, R₂, R₃, R₄ are independently alkyl, aryl, aralkyl, heteroaryl or heteroaralkyl groups, optionally substituted with one or more substituents selected from fluorine and substituents containing a functionalisable sub unit;
t is at least 1; and
u is at least 1.

38. A cyclic compound of formula (VII) 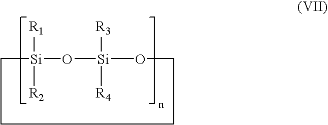
wherein R₁, R₂, R₃, R₄ are independently alkyl, aryl, aralkyl, heteroaryl or heteroaralkyl groups, optionally substituted with one or more substituents selected from fluorine and substituents containing a functionalisable sub unit; and n is at least 1.

39. A method of removing terminal OH groups from a polysiloxane according to the following scheme: 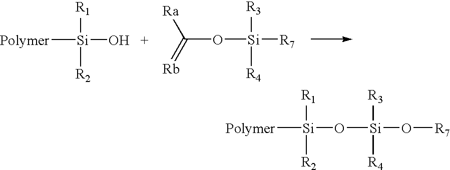
wherein:
Ra is alkyl, aryl or aralkyl;
Rb is CH₂, CH-alkyl, CH-aryl or CH-aralkyl;
R₁, R₂, R₃, R₄ and R₇ are independently alkyl, aryl, aralkyl, heteroaryl or heteroaralkyl groups, optionally substituted with one or more substituents selected from fluorine and substituents containing a functionalisable sub unit.

40. A cured polycondensate prepared by curing a polycondensate derived from at least one compound of formula (I) 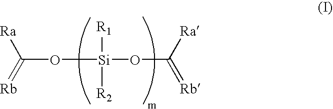
wherein:
Ra and Ra′ are independently alkyl, aryl or aralkyl;
Rb and Rb′ are independently CH₂, CH-alkyl, CH-aryl or CH-aralkyl;
R₁ and R₂, are independently selected from substituted or unsubstituted alkyl, aryl, aralkyl, heteroaryl, heteroaralkyl; and
m is at least 1.

41. A cured polycondensate prepared by curing a polycondensate as defined in claim 18.

42. A method of preparing a cured polycondensate including the step of treating a polycondensate as defined in claim 18 with a curing agent.

43. A method according to claim 42 wherein the curing agent is light.

44. A method according to claim 42 wherein the curing agent is light and a photoinitiator is added.

45. A method according to claim 43 wherein the light is UV light and the photoinitiator is selected from the group consisting of: 1-hydroxycyclohexylphenyl ketone, benzophenone, 2-chlorothioxanthone, 2-methylthioxanthone, 2-iso-propylthioxanthone, benzoin, 4,4′-dimethoxybenzoin and mixtures thereof.

46. A method according to claim 43 wherein the light is visible light and the photoinitiator is camphorquinone.

47. A method according to claim 42 wherein an initiator is added.

48. A method according to claim 47 wherein the initiator is dibenzoyl peroxide, t-butyl perbenzoate or azobisisobutyronitrile.
